(19) United States
(12) Patent Application Publication
(10) Pub. No.: US 2013/0082900 A1
(43) Pub. Date: Apr. 4, 2013

(54) ELECTROMAGNETIC WAVE DATA TRANSCEIVER DEVICE AND SYSTEM COMPRISING A PLURALITY OF SAID DEVICES

(71) Applicants: Antoni Brey Rodriguez, Barcelona (ES); Jordi Romeu Robert, Barcelona (ES)

(72) Inventors: Antoni Brey Rodriguez, Barcelona (ES); Jordi Romeu Robert, Barcelona (ES)

(73) Assignee: URBIOTICA S.L., Barcelona (ES)

(21) Appl. No.: 13/701,457

(22) PCT Filed: Jun. 1, 2010
(86) PCT No.: PCT/ES2010/070370

§ 371 Date: Nov. 30, 2012

(51) Int. Cl. H01Q 1/38; H01Q 1/24

(52) U.S. Cl. CPC H01Q 1/38; H01Q 1/24
USPC 343/906; 343/700 MS

(57) ABSTRACT

An electromagnetic wave data transceiver device suitable for installation on a post, including an antenna, and an electronic module connected to the antenna and suitable to send and receive data by way of electromagnetic wave signals transduced by the antenna. The antenna is formed in a flexible band which may be curved in the longitudinal direction thereof, passing from an open position in which the flexible band is open at one end leaving an opening for the lateral passage of a post to a closed position in which the flexible band embraces a cylindrical form. The device also includes a closure for setting the closed position of the flexible band. Also, a system formed by a plurality of the transceiver devices installed on vertical portions of posts.

### FIELD OF THE INVENTION

The invention pertains to the field of the wireless transmission of data by way of electromagnetic waves.

More particularly, the invention relates to an electromagnetic wave data transceiver device suitable for being installed on a post, comprising an antenna and an electronic module which is connected to said antenna and is suitable for sending and receiving data by way of electromagnetic wave signals transduced by said antenna.

The invention also relates to a data transmission-reception system comprising a plurality of said transceiver devices.

### STATE OF THE ART

It is known to install a transceiver device of the type first mentioned above on a post on the public way which supports illumination or luminous signalling means, such as for example a street lamp or traffic lights and which is connected to an electrical supply mains or which has its own power supply, such as, for example, a photovoltaic panel.

WO9950926A1 discloses an item of urban furniture, which may be a street lamp or traffic lights, in which there is incorporated a transceiver device for cellular telephony communications. The electronic module of this transceiver device is housed in the same casing as the electronic module of the street lamp or traffic lights, at the base of the post, and shares at least part of the circuits thereof with it. The antenna of the transceiver device is mounted at the top of the post, extending outwardly from the end of a support arm attached to the post. One drawback of this system is that the assembly thereof to an existing street lamp or traffic lights is fairly complicated. Also, the cantilevered antenna at the end of the support arm is a fragile element and, furthermore, creates a considerable visual impact.

U.S. Pat. No. 5,641,141 discloses an antenna system formed by a plurality of oblong antenna members externally attached to the post of a street lamp, parallel thereto, around the circumference of the post. This solution allows an adequate omnidirectional radiation diagram to be obtained in the plane perpendicular to the post. Nevertheless, as in the previous case, it has the drawback that the assembly of the device to an existing street lamp is fairly complicated. Another drawback of this system is that the configuration of the antenna members must be designed for a particular post diameter.

A further proposal, as disclosed in EP1376755A1, camouflages the transceiver device within the casing housing the light emitter of a street lamp, so as to protect the device and avoid the visual impact caused thereby. This solution has the drawback of requiring a specific design of the street lamp light emitter and, in any case, does not allow the device to be installed on any type of existing street lamp.

### SUMMARY OF THE INVENTION

It is an object of the invention to provide a transceiver device of the type first mentioned above, which may be easily installed on any existing post, preferably but not limited to a street lamp or traffic light post, without the need to carry out substantial modifications and obtaining an adequate diagram of omnidirectional radiation in the plane perpendicular to the post.

This object is attained by a transceiver device of the type first mentioned above, characterised in that the antenna is formed in a flexible band which may be curved in the longitudinal direction thereof, passing from an open position in which said flexible band is open at one end leaving an opening for the lateral passage of a post, to a closed position in which said flexible band embraces a substantially cylindrical form, and in that it comprises closing means to set said closed position of the flexible band.

Thanks to this configuration, the transceiver device may be easily installed on a post like a flexible collar, disposed on the outside of said post and at any height along it. The installation operation is very simple. It consists of opening the flexible band at one end to form the aforementioned opening, causing the post to pass laterally through said opening and thereafter closing the flexible band and setting this closed position, in which the flexible band is disposed like a collar around the post. Furthermore, this configuration allows the flexible band to adopt a predetermined cylindrical form in its closed position, substantially independent of the shape and width of the post. Thus, there may be a single design of the antenna formed in the flexible band for a wide range of posts. On the other hand, thanks to the configuration of the antenna in form of a band closed upon itself, which adopts a substantially cylindrical form, and that such band is disposed in the open air on the outside of the post, there is advantageously obtained an omnidirectional radiation diagram well distributed in the plane perpendicular to the post.

The antenna is preferably configured as a patch antenna comprising at least three superimposed layers: a first conductive layer forming a ground plane, a second conductive layer forming radiating patches and an intermediate layer of dielectric material interposed between said first and second conductive layers, said first conductive layer which forms a ground plane being disposed in the innermost position of said flexible band in the closed position thereof. This configuration corresponds to that of a patch type antenna, but with the peculiarity that the member forming the antenna is a flexible band that may adopt the said curved positions. It affords the advantage that it may be mass-produced at low cost.

In advantageous embodiments, the antenna is configured as a patch antenna comprising at least five superimposed layers: a first conductive layer forming a ground plane, a second conductive layer forming radiating patches, a third conductive layer forming further radiating patches formed in such a way as to project into the radiating patches of the second conductive layer, and respective intermediate layers of dielectric material interposed respectively between the first and second conductive layers and between the second and third conductive layers, said first conductive layer which forms a ground plane being disposed in the innermost position of the flexible band in the closed position thereof. This configuration corresponds to that of a patch type antenna similar to the one described above, but which comprises two superimposed conductive layers each forming radiating patches. In this way there is obtained a multiband antenna in which each group of radiating patches may operate at a different radiation frequency. Thanks to the radiating patches of the third conductive layer are projected within the radiating patches of the second conductive layer, it is not necessary to add to the flexible band a conductive layer forming a ground plane for the radiating patches of the third conductive layer, since the ground plane function for the latter is effected by the radiating patches of the second conductive layer. Obviously, other embodiments are possible in which the patch antenna comprises more than five layers, disposed according to the same principle consisting of superimposing the conductive layers forming the radiating patches in such a way that the patches of one layer serve as ground plane for the radiating patches of the following layer.

The layers of the patch antenna are preferably formed in independent flexible bands that are superimposed one on the other to jointly form said flexible band in which the antenna is formed. This configuration affords the advantage of a lower manufacturing cost, thanks to the layers being individually manufactured and it is not necessary to provide a mechanical bonding of the latter during the manufacturing process of the flexible band forming the antenna. Furthermore, it allows a patch antenna having five layers like the one described above to be made with particular ease.

The conductive layers are preferably printed on the surface of said corresponding independent flexible bands, for example, by printing a conductive paint or ink. Thanks to this configuration, the conductive layer does not reduce the flexibility of the independent flexible band on which it is formed. Advantageously, this independent flexible band may be made from a semi-rigid plastics material and dimensioned with a small thickness to obtain an adequate flexibility of the band. This solution affords the advantage that, in a closed position of the flexible band, this adopts a substantially cylindrical form without the need to bear against another cylindrical body. Other embodiments are possible in which one of these independent flexible bands having a conductive layer printed thereon is made from a semi-rigid plastics material, thereby providing the said advantages, while the other independent flexible bands having a conductive layer printed thereon are made from another non-rigid material, such as for example, a non-woven fabric.

The intermediate layers of dielectric material interposed between two of said conductive layers are preferably formed by the independent flexible band itself, made from a foam material. This material is particularly appropriate since, on the one hand, it allows an independent flexible band to be made with adequate mechanical properties of strength and flexibility and, on the other hand, the band formed from this material forms of itself a layer of dielectric material, since the foamed nature of the material means that it has a dielectric constant close on that of the air.

The electronic module is preferably housed in a casing fixedly attached to the flexible band, whereby during installation of the device to a post it is not necessary to provide a connecting system of the electronic module to the antenna formed from the flexible band. The thus formed device is an integral kit which is installed directly around the post.

In advantageous embodiments, said casing housing the electronic module is situated in the inner space defined by the flexible band in the closed position of the latter. This configuration provides the advantage of the flexible band on which the antenna is formed being able to occupy 360 degrees of circumference, whereby it is easier to obtain a good omnidirectional distribution of the radiation diagram in a plane perpendicular to the post.

In other embodiments, said casing housing the electronic module is located on the longitudinal extension of the flexible band, such that in the closed position of the flexible band, the ensemble formed by the latter and the casing housing the electronic module closes a substantially cylindrical inner space. This solution makes the device installed on a post more robust, since the constructional configuration of the device is simpler and also the distance between the flexible band and the post is reduced. The drawback is that the flexible band does not form a complete 360-degree wrap due to the space occupied by the electronic module. This makes it difficult to obtain an omnidirectional radiation diagram in a plane perpendicular to the post. Nevertheless, this difficulty is overcome by designing the casing housing the electronic module in such a way as to occupy a small circular sector and designing the antenna in an appropriate way.

The device preferably comprises fixation means for attaching said device to the outer surface of a post. In the preferred embodiments, said fixation means are disposed on the surface of the casing facing the post and are suitable to be press fit into mating means disposed on the outer surface of the post. Thanks to this configuration, it is particularly easy to install the device on a post: once the mating fixation means have been installed on the post, it is sufficient to offer up the device with the casing facing said mating means, press towards the post to make the press fit and finally close the flexible band on itself around the post.

The device according to the invention may be provided with its own power supply means, such as for example very long-life batteries or a photovoltaic plate, such that it may be installed on any post without the need to have a supply point through an electric mains available.

Nevertheless, a preferred application of the device according to the invention consists of installing it on posts already having a supply point through an electric mains, such as are the posts of street lamps or traffic lights, and connecting the device to said supply point. Thus, preferably, the device comprises means for connexion to an electric mains external to said device, for feeding the electronic module in its function of sending and receiving data by electromagnetic wave signals transduced by the antenna.

The fixation means preferably have a tubular configuration defining a bore for the passage of a cable forming part of the connexion means to an electric mains external to the device. As will be seen later in the detailed description of embodiments, this solution allows the installation of the device and its connexion to the electric mains external thereto to be performed very easily, in particular the connexion to a supply point located inside a street lamp or traffic light post.

The device preferably comprises an electric power accumulator, suitable for accumulating electric power provided by said external electric mains external to the device, and for feeding the electronic module, in its function of sending and receiving data by electromagnetic wave signals transduced by the antenna, in the absence of supply from said external electric mains external to said device. This allows the device to continue being operative when the source of electric power from the post is interrupted. For example, when the device is installed on a lamppost it is directly connected, through the connexion means, to the electric mains feeding the lamp. During the time that the lamp is receiving current, the electronic module functions with the power provided by said electric mains, which at the same time charges the electrical power accumulator. During the time that the lamp is disconnected from the mains, the electric power accumulator takes over and feeds the electronic module.

The invention relates, further to the transceiver as such, to an electromagnetic wave data transmission-reception system comprising a plurality of said transceiver devices installed on substantially vertical portions of posts, with the flexible band attached in the closed position thereof externally embracing said vertical portion of the post. This system provides a particularly efficient wireless communications network, allowing the exchange of data among the devices themselves installed on the vertical portions of the posts, as well as between each one of these and other transceivers located in the surroundings close to the ground, such as for example ground moisture sensors, vehicle presence sensors in parking places, etc. The antennas may be installed on the posts at any height, preferably at a level sufficiently high so as not to be directly accessible to avoid acts of vandalism. Thanks to said antennas being disposed in the form of a ring having a vertical axis externally embracing the post, they offer an omnidirectional radiation diagram in the plane perpendicular to the post which is particularly appropriate for communicating with the other antennas installed on neighbouring posts, as well as with other transceiver devices located close to ground level.

In a preferred application, said posts are posts which support illumination or signalling equipment, such as lampposts or traffic lights, connected to an electric mains system, and the transceiver devices installed in said posts are connected, on each of said posts, to the same power point of said electric mains as to which the to illumination or signalling equipment supported by the post is connected.

Preferably in said posts, the connexion cable passing through the bore formed in the complementary fixation means disposed on the outside wall of the post is laid in the hollow interior of the post, from said complementary fixation means to the electrical junction box at the base of the post.

### BRIEF DESCRIPTION OF THE DRAWINGS

Further advantages and features of the invention will be appreciated from the following description in which, without any limiting nature, there is disclosed a preferred embodiment of the invention, with reference to the accompanying drawings, in which:

FIG. 1 is a perspective view of one embodiment of a transceiver device according to the invention, with the flexible band in the open position, located in front of a vertical portion of a post on which it is to be installed;

FIG. 2 is a perspective view of the device of FIG. 1, after having been installed on the post and with the flexible band fixed in the closed position thereof;

FIG. 3 is a plan view of the three independent flexible bands forming the flexible band of the device of FIGS. 1 and 2;

FIG. 4 is a perspective view of the device of FIG. 1, in the same position, from an opposite side;

FIG. 5 is a similar view to that of FIG. 4, showing only the vertical post portion and the system for fixing the device to the post;

FIG. 6 is a side view of a post for supporting a street lamp or traffic lights on which there is installed a device according to the invention, where the connexion cable extending inside the post and the supply point to which it is connected have been shown schematically;

FIG. 7 is a view similar to FIG. 3 showing a variation in which the flexible band comprises five layers;

FIG. 8 is a view similar to FIG. 2 showing an alternative solution for the arrangement of the casing housing the electronic module;

FIG. 9 is a schematic view of an electromagnetic wave data transmission-reception system formed by a plurality of transceiver devices according to the invention installed on vertical posts in the public way.

### DETAILED DESCRIPTION OF EMBODIMENTS OF THE INVENTION

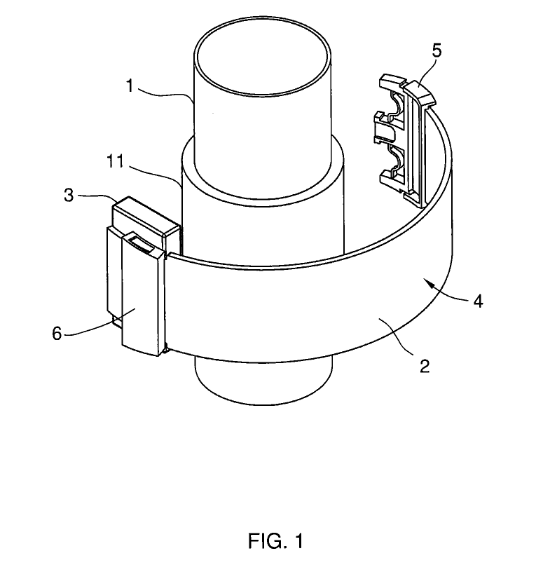

The transceiver device shown in FIGS. 1 to 5 is specially designed for ease of installation on a post, like a ring embracing the outside of the post. It is formed by a flexible band 4 forming an antenna 2 and which is fixedly attached to a housing 3 in which there is housed an electronic module (not shown). The electronic module is connected to the antenna 2 and comprises the necessary electronic elements for sending and receiving data by way of electromagnetic wave signals, which in this case are radio frequency (RF) waves, transduced by the antenna 2. It is not deemed necessary to provide here a detailed description of these electronic elements, since they are conventional elements having no peculiarity related to the invention and which are available to a person skilled in the art. These elements mainly comprise a supply system, one or more microprocessors and the radio frequency transmission and reception circuits operating directly on the same antenna.

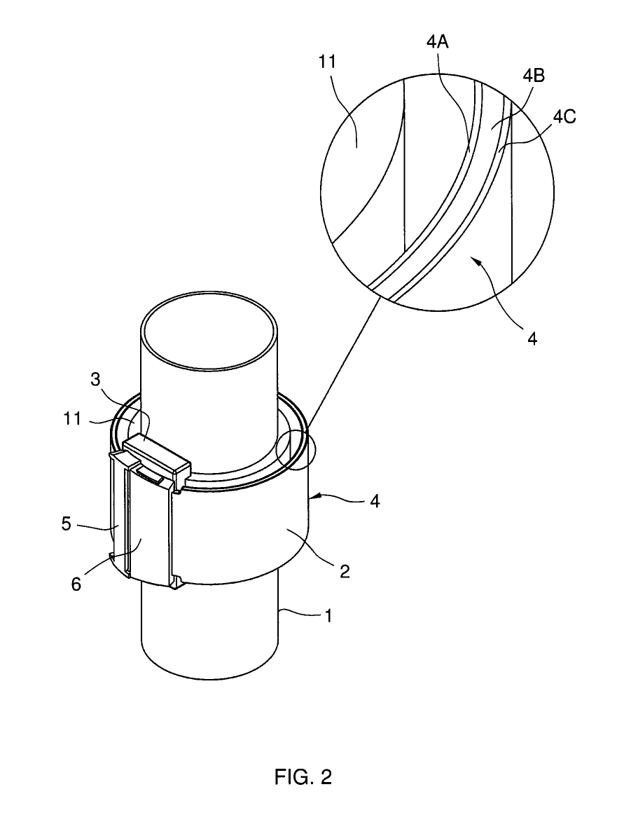

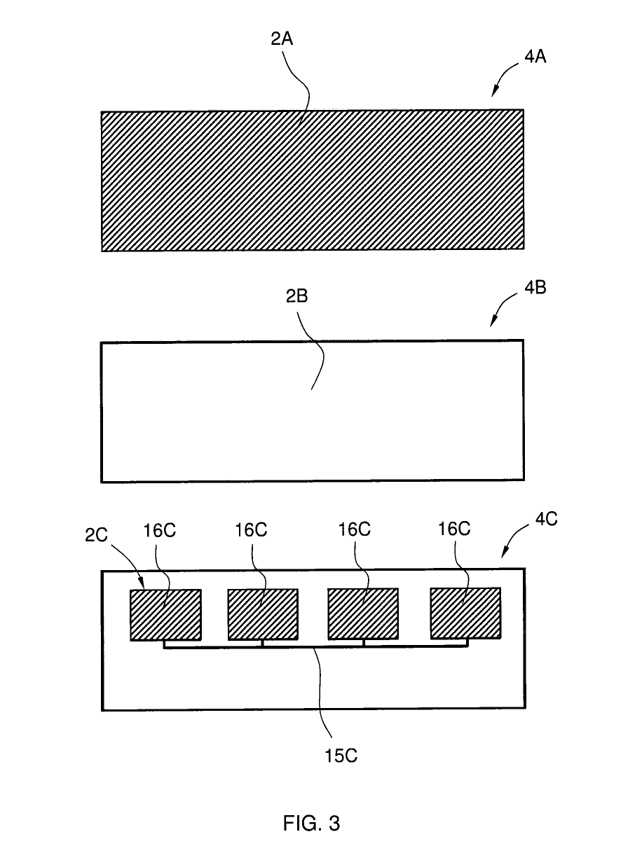

The antenna is a patch antenna comprising three superimposed layers 2A, 2B, 2C formed from respective independent flexible bands 4A, 4B, 4C which jointly constitute the flexible band 4. FIG. 2 includes a detail on a larger scale showing the edge of the flexible band 4, in which the superimposition of the three bands 4A, 4B, 4C is to be seen. FIG. 3 shows a plan view of each of these three bands 4A, to 4B, 4C. The band 4A is a band made from a flexible plastics material, in this case a thermoplastic polyimide type polymer having a thickness of less than one millimetre, having printed on one of its sides a first conductive layer 2A occupying the entire surface of said band 4A, thereby forming a ground plane. This first conductive layer 2A is formed by printing with a conductive ink, which in this case is made from silver or copper. Band 4B is a foamed plastic band, in this case polyurethane, having a thickness of 5 to 10 millimetres. Thanks to its foamed nature, the material of the band 4B has a dielectric constant close to that of the air, whereby the band 4B forms of itself an intermediate band 2B of dielectric material. Band 4C is made from the same material as band 4A and has the same thickness. It carries a second conductive layer 2C printed on one of its sides which forms radiant patches 16C, in this case four in number, connected together by a conductive track 15C. This second conductive layer 2C is made in the same way as the first conductive layer 2A, i.e. by printing with the same conductive ink on one of the sides of the band 4C. The three bands 4A, 4B, 4C have the same dimensions when seen in plan view. In this embodiment, these dimensions are as follows: 53 cm long by 16 cm wide. As may be seen in the detail view of FIG. 2, the band 4A, and therefore the first conductive layer 2A forming a ground plane, is disposed in the innermost position of the flexible band 4 in the closed position thereof.

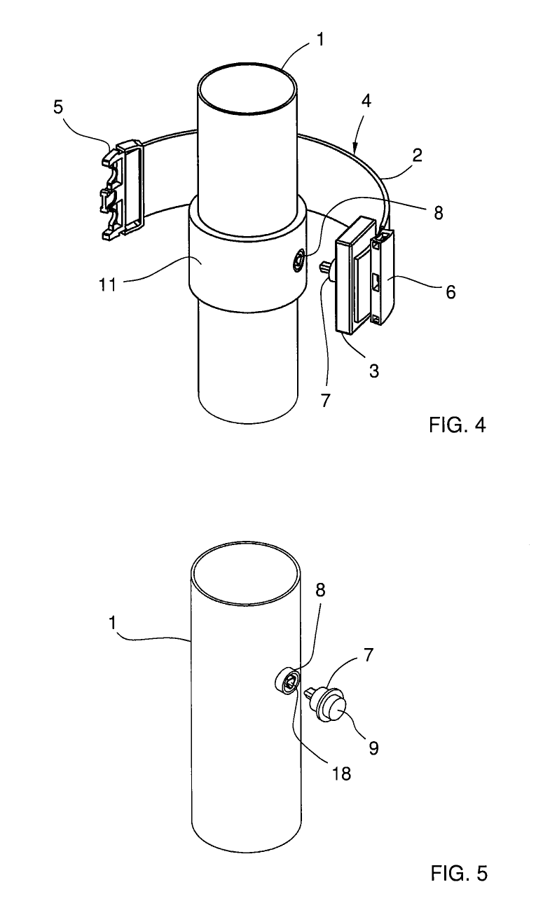

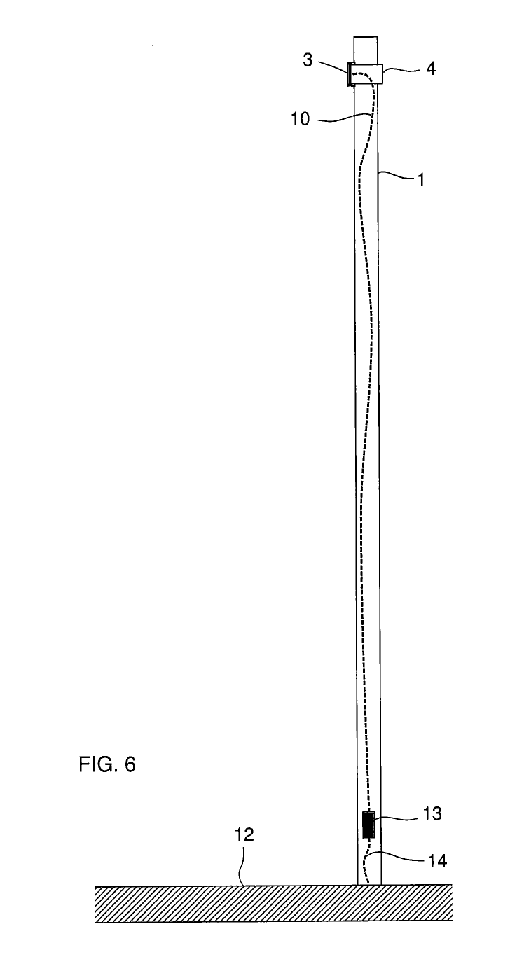

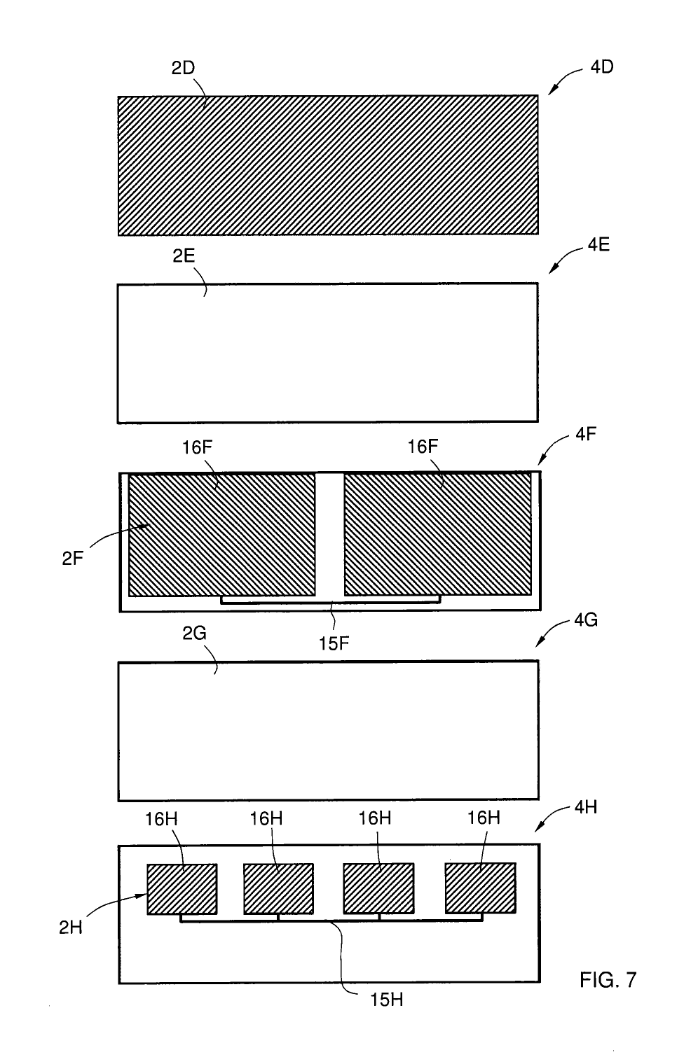

As may be seen in FIGS. 1, 2 and 4, the flexible band 4, in which the antenna 2 is formed by stacking of the layers 2A, 2B, 2C formed in the independent bands 4A, 4B, 4C, is a flexible band which may be curved in the longitudinal direction thereof, passing from the open position shown in FIGS. 1 and 4 in which the flexible band 4 is open at one end leaving an opening for the post 1 to pass laterally therethrough, to a closed position shown in FIG. 2 in which the flexible band embraces the post 1 externally in a substantially cylindrical fashion. A filling band 11, made from a compressible material such as for example a foamed rubber, is optionally fitted on the outer surface of the post 1, serving to obtain a better fit of the device to the post 1.

The flexible band 4 has mounted at its ends closing means 5, 6 serving to fix the closed position thereof, as shown in FIG. 2. These closing means consist of a quick snap-fit closing system, comprising a male member 5 disposed on one of the ends of the flexible band 4 and a mating female member 6 disposed at the other end of the flexible band 4. As may be seen in FIGS. 1 and 4, the female member 6 is solidly attached to the outer surface of the casing 3 housing the electronic module, in such a way that an end portion of the flexible band 4 is trapped between said outer surface of the casing 3 and said female member 6. Thus, in the closed position of the flexible band 4, both ends thereof substantially abut each other, such that the flexible band 4 completely covers 360°. The casing 3 is thus located in the inner space defined by the flexible band 4 in its closed position. The electrical connexion between the antenna 2 and the electronic module housed within the casing 3 is advantageously made in the end portion of the flexible band 4 trapped between the female member 6 and the outer surface of the casing 3.

For the attachment of the device to the outer surface of the post 1, there are used fixation means 7 which are disposed in the surface of the casing 3 facing the post 1 and which press fit in mating means 8 which are previously installed on the outer surface of the post 1. These mating means consist of a pin 8 that is forcibly inserted into a hole formed in the wall of the post 1. The pin 8 has a bore 18 for the passage of a cable 10 for connecting the device to an electric mains. The said fixation means consist of a tubular member 7 defining a bore 9 for the passage of said cable 10. One end of the bore 9 opens out into the interior of the casing 3 (not shown), while the other end is connected in the bore 18 of the pin 8. The cable 10 is part of the means for connexion of the device to an electric mains external to the device, allowing the electronic module to receive a power supply in its function of sending and receiving data by way of electromagnetic wave signals transduced by the antenna 2. These connexion means include electronic devices for protection and adaptation of the voltage which are housed within the casing 3. It is not deemed necessary to give details here of these electronic devices, since they will be obvious to a person skilled in the art.

It is particularly easy to install the device on the post 1 of a street lamp or traffic lights. The installer freely selects the height on the post 1 where it is desired to install the device, forms a hole through the wall of the post 1 and forcibly inserts the pin 8 into said hole. He may optionally fit the filling band 11. Thereafter he feeds the connexion cable 10 of the device through the bore 18 of the pin 8 and slides it along until it reaches the junction box 13 located at the foot of the post. He then disposes the device with the flexible band 4 in the open position, passes the post 1 through the opening left between the ends of said flexible band 4, places the casing 3 facing the pin 8 and presses the casing towards the post 1 to press fit the tubular member 7 and the pin 8 together. The device is thus firmly attached to the post 1 and it is only necessary to close the flexible band 4 on itself and fix it in position by pressing the closing means 5, 6 together. The connexion of the cable 10 to the electric mains 14 supplying the street lamp or traffic lights supported by the post 1 is effected by comfortably working at the base of the post close to ground level 12, through the access door to the junction box 13 which lampposts or traffic light posts typically have.

The casing 3 also houses an electric power accumulator which accumulates the electric power provided by the external mains 14 and which is capable of providing power to the electronic module in its function of sending and receiving data by way of electromagnetic wave signals transduced by the antenna, when the supply from the external electric mains 14 is interrupted. This accumulator consists of a long life chemical battery having an extended temperature range, in this case of the ion lithium type.

FIG. 7 shows a constructional variant of the flexible band 4. It is formed by a plurality of independent flexible bands on which the different layers of a patch type antenna are formed, of the same shape and with the same materials as for the antenna of FIG. 3 described above, but with the difference that the independent flexible bands are five in number: a first conductive layer 2D forming a ground plane, a second conductive layer 2F forming two radiating patches 16F, connected by a conductive track 15F, a third conductive layer 2H forming four radiating patches 16H, connected by a conductive track 15H, and respective intermediate layers 2E, 2G of dielectric material interposed respectively between the first and second conductive layers 2D, 2F and between the second and third conductive layers 2F and 2H. The radiating patches 16H are projected into the radiating patches 16F, whereby the latter 16F work as a ground plane for the former 16H. As in the case of the antenna described in FIG. 2, the band 4D, and therefore the first conductive layer 2D forming a ground plane, is disposed in the innermost position of the flexible band 4 in the closed position thereof. The thus configured antenna 2 can operate as a multiband antenna, since the radiating patches 16F and the radiating patches 16H can transmit and receive on different frequency bands.

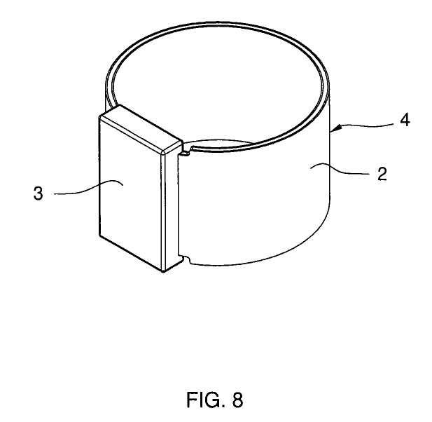

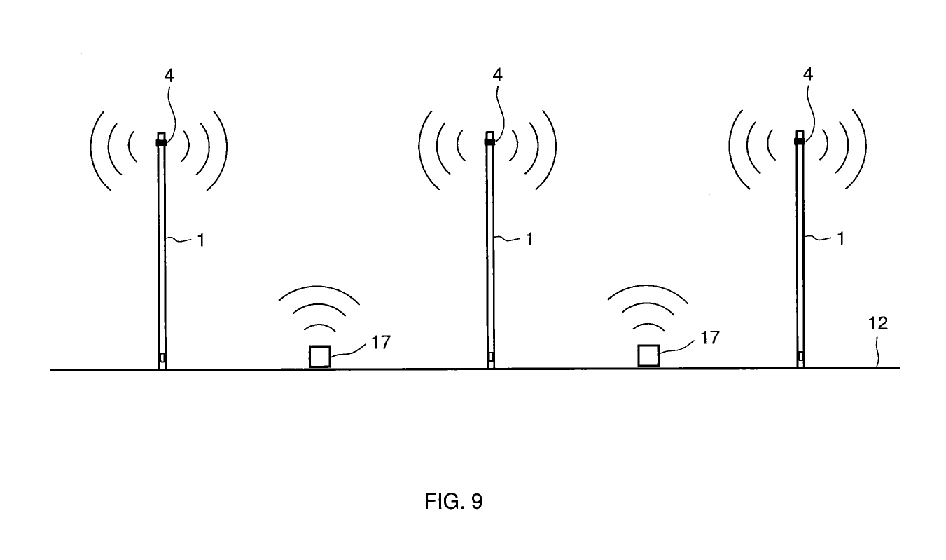

FIG. 8 shows an alternative solution for the disposition of the casing 3 housing the electronic module. In this case, the casing 3 is located on the longitudinal extension of the flexible band 4. The closing means for the closed position of the flexible band 4 are not detailed in the Figure. They consist of a male member disposed at one of the ends of the flexible band 4 which is a snap fit in an opening formed on a side wall of the casing 3. The other end of the flexible band 4 is attached to the other sidewall of the casing 3. The electrical connexion between the antenna 2 and the electronic module housed in the casing 3 is made at this end.

FIG. 9 schematically shows an electromagnetic wave data transmission-reception system formed by a plurality of transceiver devices like those just described installed on vertical street lamp or traffic light posts 1, as described hereinbefore. The figure schematically shows transceiver devices 17 which are located close to the ground 12 and which exchange data by electromagnetic waves with the transceiver devices installed on the posts 1. The latter exchange data by electromagnetic waves both with one another and with the devices 17 located close to the ground. These devices 17 are advantageously different types of sensors which capture different variables of the surroundings, such as for example, the ground moisture level, the presence of a vehicle in a parking place, etc.

1.-16. (canceled)

17. An electromagnetic wave data transceiver device comprising an antenna and an electronic module connected to said antenna and adapted for sending and receiving data by way of electromagnetic wave signals transduced by said antenna,
wherein said antenna is formed in a flexible band, passing from an open position in which said flexible band is open at one end leaving an opening for the lateral passage of a support, to a closed position in which said flexible band embraces a substantially cylindrical form, and closing means to set said closed position of the flexible band.

18. A device according to claim 17,
wherein said antenna is a patch antenna comprising at least three superimposed layers: a first conductive layer forming a ground plane, a second conductive layer forming radiating patches and an intermediate layer of dielectric material interposed between said first and second conductive layers, said first conductive layer being disposed in an innermost position of said flexible band in the closed position thereof.

19. A device according to claim 17,
wherein said antenna is a patch antenna comprising at least five superimposed layers: a first conductive layer forming a ground plane, a second conductive layer forming radiating patches, a third conductive layer forming further radiating patches formed in such a way as to project into said radiating patches of the second conductive layer and respective intermediate layers of dielectric material interposed respectively between said first and second conductive layers and between said second and third conductive layers, said first conductive layer being disposed in the innermost position of said flexible band in the closed position thereof.

20. A device according to claim 18, wherein said layers of the patch antenna are formed on independent flexible bands which are superimposed one upon the other to jointly form said flexible band in which said antenna is formed.

21. A device according to claim 20,
wherein the conductive layers are printed on a surface of said corresponding independent flexible bands.

22. A device according to claim 20,
wherein said intermediate layers of dielectric material interposed between two of said conductive layers are constituted by the independent flexible band itself made from a foamed material.

23. A device according to claim 21,
wherein said intermediate layers of dielectric material interposed between two of said conductive layers are constituted by the independent flexible band itself made from a foamed material.

24. A device according to claim 17,
wherein said electronic module is housed in a casing fixedly attached to said flexible band.

25. A device according to claim 24,
wherein said casing is located in an inner space defined by said flexible band in the closed position thereof.

26. A device according to claim 24, wherein said casing is located on a longitudinal extension of said flexible band.

27. A device according to claim 24, further comprising a fixation member for attaching said device to an outer surface of a support, said fixation member being disposed on a surface of said casing facing said support and received by a receptacle disposed on an outer surface of said support.

28. A device according to claim 27, further comprising a connector to an electric source external to said device, for powering the electronic module for sending and receiving data by way of electromagnetic wave signals transduced by said antenna.

29. A device according to claim 28, wherein said fixation member has a tubular configuration defining a bore for passage of a cable forming part of the connector.

30. A device according to claim 28, further comprising an electric power accumulator accumulating electric power provided by said electric source, and for powering said electronic module, in the absence of supply from said electric source.

31. An electromagnetic wave data transmission-reception system, further comprising a plurality of transceiver devices according claim 28, installed on portions of the support, each said flexible band being attached in the closed position thereof externally embracing said support portion.

32. A system according to claim 31, wherein said supports support illumination or signalling equipment connected to the electric source, and wherein said transceiver devices are connected, on each of said supports, to a same point of said electric source as to which the illumination or signalling equipment supported by said support is connected.

33. A system according to claim 29, wherein said cable is laid along a hollow interior of said post, from said receptacle to a junction box at a base of said support.
